(19) United States
(12) Patent Application Publication
(10) Pub. No.: US 2018/0279761 A1
(43) Pub. Date: Oct. 4, 2018

(54) DENTAL CLEANING DEVICE USING OZONATED WATER

(71) Applicant: Gaby Milad Haddad, Abu Dhabi (AE)

(72) Inventor: Gaby Milad Haddad, Abu Dhabi (AE)

(21) Appl. No.: 15/766,313

(22) PCT Filed: Oct. 4, 2016
(86) PCT No.: PCT/IB2016/055916

§ 371 Date: Apr. 5, 2018

(30) Foreign Application Priority Data
Oct. 6, 2015 (FR) 1559503

(51) Int. Cl. A46B 11/06; A46B 15/00; A61C 17/02; A46B 9/04; A46B 5/00

(52) U.S. Cl. CPC A46B 11/066; A46B 15/0071; A46B 15/0024; A46B 15/003; A61C 15/048; A46B 9/04; A46B 5/0095; A46B 2200/1066; A61C 17/0217

(57) ABSTRACT

A dental cleaning device for personal use, said device comprising a main base comprising at least one drinking water inlet and one water outlet and a cleaning element suitable to be hand held by a user and fluidly connected to the said main base, the said cleaning element comprising a plurality of water ejection orifices to enable the teeth to be rinsed, the main base comprising ozone injection means so as to supply ozonated water to disinfect the teeth when rinsing.

### TECHNICAL FIELD

This invention relates to the field of equipment enabling dental cleaning, in particular, for personal use.

In a known way, in order to perform dental cleaning, the teeth are brushed with a toothbrush to which toothpaste is applied. After brushing and rinsing, dental floss may also be used to clean the space between two consecutive teeth.

When cleaning, the rinsing of teeth is generally poorly performed and particles of food remain in contact with the teeth, which represents a first drawback. The same applies to flossing, for which rinsing is generally omitted. Furthermore, flossing may result in cuts to the gums that are not disinfected, which represents another drawback.

Incidentally, a dental cleaning device is known in the prior art, through patent application US20100124729, comprising a toothbrush connected to a water inlet.

In practice, many people dislike toothpaste, both due to its consistency and its appearance, and reduce their frequency of brushing. Similarly, toothpaste is not suitable for young children who are likely to ingest it, which presents a risk to their health. Also, there is a need for a teeth-cleaning procedure that is better accepted both by children and adults.

The aim of the invention is therefore to eliminate these drawbacks by proposing a new dental cleaning device that cleans a person's teeth in an efficient and practical manner.

### SUMMARY

For this purpose, the invention relates to a dental cleaning device for personal use, said device comprising:
a main base comprising at least one drinking water inlet and one water outlet, and
a cleaning element suitable to be hand held by a user and fluidly connected to the said main base, the said cleaning element comprising a plurality of water ejection orifices to enable the teeth to be rinsed.

The device is remarkable in that the main base comprises ozone injection means so as to supply ozonated water to disinfect the teeth when rinsing.

Thanks to the invention, the use of toothpaste can advantageously be avoided, given that the ozonated water enables the teeth to be disinfected and can be ingested without danger by the users, particularly young children. Furthermore, such a cleaning device offers a disinfecting rinse both when brushing and when flossing, affording optimum protection.

Preferably, the water ejection orifices are oriented towards one part of the cleaning element so as to enable indirect rinsing and avoid loosening the teeth and/or gingival recession.

Preferably, the ozone injection means are configured to generate ozone by electrolysis of the drinking water. Thus, the main base allows ozone to be injected independently, with no external source.

More preferably, the main base comprises heating means so as to supply ozonated, heated water to disinfect the teeth during rinsing. Preferably, the heating means are configured to supply water heated to between 50° C. and 55° C. This temperature helps to dissolve sticky residues, such as sweets, and to prevent discoloration of the teeth by coffee, black tea or other foods. Lastly, heated water stimulates the blood circulation of the gums, increasing resistance to inflammation.

According to a preferred aspect of the invention, the main base is mounted in a casing suitable for fixing to a vertical wall. Thus, a user can simply install the dental cleaning device in his bathroom, which is advantageous.

According to a preferred aspect of the invention, the cleaning element comprises a main body onto which a cleaning head is removably mounted, the said cleaning head comprising a plurality of water ejection orifices to enable the user's teeth to be rinsed. Thus, the cleaning element can have cleaning heads with different functions in order to allow optimum cleaning without using several independent devices.

The invention also relates to an assembly comprising a dental cleaning device and a plurality of cleaning heads, in particular, a brush-type cleaning head and a floss-type cleaning head.

According to one aspect, the cleaning head is of the brush type and is composed of a rigid element comprising a plurality of bristles, the ejection orifices being arranged around the periphery of said rigid element. Preferably, the ejection orifices are oriented so as to moisten the top part of the central bristles, preferably, only the top quarter of the central bristles. Due to their arrangement, the peripheral bristles advantageously do not interfere with the ejection of ozonated water towards the top part of the central bristles, which is advantageous. Thus, the ozonated hot water can act on the teeth and gums during brushing. Any direct ejection of ozonated water onto the teeth is thus avoided.

Preferably, since the rigid element extends longitudinally, the bristles are longer in the center of the rigid part than at its ends in a cross-sectional plane. Thus, the ozonated water jets can advantageously be inclined to rinse the teeth in their brushing zone. Advantageously, the bristles located round the periphery do not interfere with the jets.

According to another aspect, the cleaning head is of the floss type and is composed of a rigid element comprising two portions spaced apart between which a stretched length of dental floss is mounted. Such a cleaning head allows the spaces between the teeth to be cleaned whilst enabling rinsing when flossing.

Preferably, each spaced-apart portion comprises at least one ejection orifice. Thus, rinsing is achieved laterally so as to rapidly remove any residue dislodged during flossing. More preferably, each ejection orifice is oriented towards said dental floss, and rinsing is therefore optimal. Each residue dislodged by the dental floss is then directly removed.

Preferably, the dental-floss type cleaning head comprises an abutment element parallel to said dental floss. The abutment element is mounted behind said dental floss to come into contact with the teeth and prevent the dental floss from coming into contact with the gums. Preferably, the abutment element is of rubber to allow soft contact with the teeth, thus improving comfort of use.

### BRIEF DESCRIPTION OF THE DRAWINGS

The invention will be better understood by reading the following description, given purely by way of example, and by referring to the accompanying drawings in which:

FIG. 1 is a schematic representation of an embodiment of a cleaning device according to an embodiment of the invention;

FIG. 2 is a schematic representation of a cleaning element with a brush-type cleaning head;

FIG. 3 is a cross-sectional view of a brush-type cleaning head;

FIG. 4 is a top view of a brush-type cleaning head; and

FIG. 5 is a schematic representation of a cleaning element with a dental floss-type cleaning head.

Note that the figures show the invention in detail in order to implement the invention, clearly said figures can serve to better define the invention if necessary.

### DETAILED DESCRIPTION

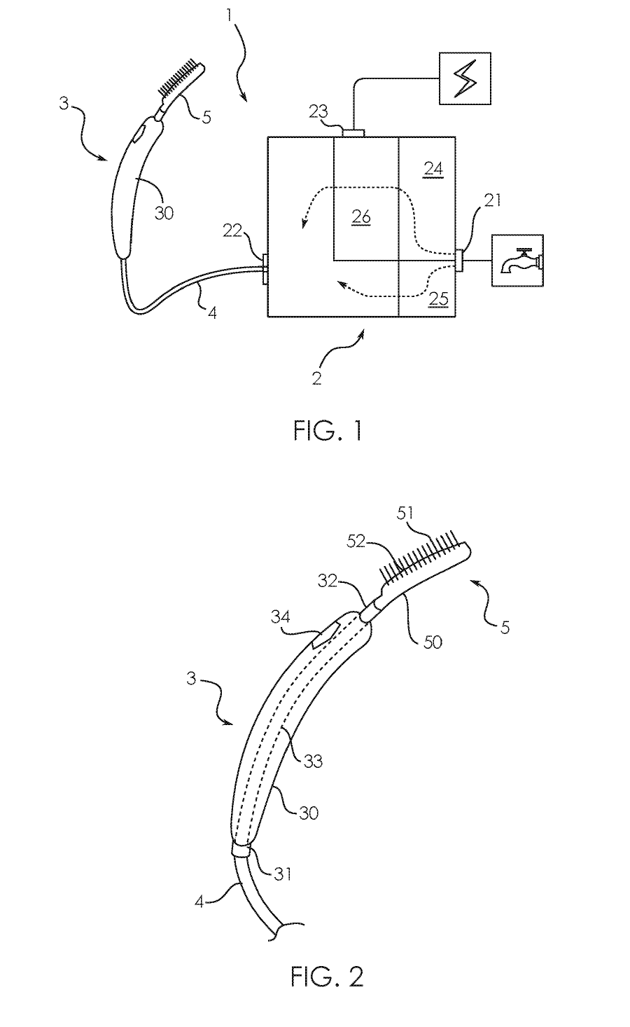

FIG. 1 shows a dental cleaning device 1 according to an embodiment of the invention. The dental cleaning device 1 comprises a main base 2, which is mechanically and fluidly connected to a cleaning element 3 by means of a main pipe 4, which is flexible to make the cleaning element 3 easy to handle, whereas the main base 2 is fixed. As will be described later, the cleaning element 3 comprises a cleaning head allowing water to be ejected so as to improve rinsing.

As illustrated in FIG. 1, the main base 2 comprises an inlet 21 suitable for connection to a drinking water supply, for example a bathroom tap, and an outlet 22 suitable for connection to the main pipe 4 in order to supply the cleaning element 3 with water as will be later described.

Preferably, to enable pressurized circulation in the main pipe 4, the main base 2 also comprises a feed pump (not shown), which is suitable for supplying a flow of pressurized water via the outlet 22. As illustrated in FIG. 1, the main base 2 comprises an electrical connection 23 suitable for electrically supplying the said feed pump.

According to the invention, the main base 2 also comprises ozone injection means 25 in order to add ozone to the drinking water arriving through the inlet 21 so that the water circulating in the main pipe 4 is ozonated. Preferably, the ozone injection means 25 are configured to generate ozone by electrolysis of the incoming water. For this purpose, the ozone injection means 25 are housed in the main base 2 and connected to the water supply inlet 21 so as to generate ozone to be injected into the flow of water from the outlet 22 of the main base 2.

Nevertheless, it goes without saying that the ozone injection means 25 could also inject into the outgoing flow of water the ozone stored in an ozone reservoir in the main base 2.

Furthermore, in this embodiment, the main base 2 comprises means 26 to heat the water so as to improve the action of the ozone, in particular, to between 50° C. and 55° C. This heated water improves dissolving of residues during brushing, combats discoloration of the teeth and strengthens the gums against the risk of inflammation. Preferably, the heating means 26 take the form of a heating resistor. It goes without saying that other heating means could be used. The heating means 26 are adapted to heat the incoming water flow from the inlet 21. As illustrated in FIG. 1, the outgoing water flow from the outlet 22 of the main base 2 is formed of a mixture of heated water and ozone. Thus the flow of outgoing water is perfectly suitable for rinsing and disinfecting the teeth.

Preferably, with reference to FIG. 1, the main base 2 also comprises filtration means 24 suitable for filtering the water from the inlet 21. In this example, the filtration means 24 comprise a carbon filter. The filtration means 24 are preferably located next to the inlet 21 so as to achieve preliminary filtering on heating and preliminary filtering on generating ozone.

According to one aspect of the invention, the main base 2 also comprises a switch (not shown) to activate the heating means 26, the feed pump and the ozone injection means 25.

In this embodiment, the main base 2 takes the form of a single casing, which can be mounted on a vertical wall, in particular, near a washbasin to enable its connection to the drinking water supply. Preferably, the casing comprises a support for the cleaning element 3.

With reference to FIG. 2, the cleaning element 3 comprises a main body 30 extending longitudinally. The main body 30 comprises a lower connector 31 and an upper connector 32, which are connected by an internal channel 33 formed in the said main body 30. The cleaning element 3 also comprises a cleaning head 5 that is preferably mounted removably on the main body 30 as will be described later.

The main pipe 4 of the dental cleaning device 1 is suitable for connection, in particular, removably, to the lower connector 31 of the cleaning element 3. For this purpose, a plug- or screw-in connection is particularly suitable.

Similarly, the cleaning head 5 is suitable for connection, in particular, removably, to the upper connector 32 of the main body 30. For this purpose, a plug- or screw-in connection is particularly suitable.

The main body 30 is suitable to be hand held by a user. Also, it is between 13 cm and 18 cm in length. The main body 30 is ergonomically curved for optimum grip. It has a circular cross-section, which preferably varies along its length. As an example, the main body 30 has a central section of a diameter of between 1.5 cm and 2 cm with ends of a smaller section. Preferably, the main body 30 has an end section near the first connector 31 of a diameter of between 1 cm and 1.5 cm and an end section near the second connector 32 of a diameter of between 1.2 cm and 1.7 cm.

In this embodiment, the main body 30 also comprises an indentation 34, located near the upper connector 32, to receive the user's thumb. This indentation 34 also improves the ergonomics when handled by the user.

As shown in FIG. 2, the cleaning head 5 is, in this embodiment, a brush that comprises a rigid element 50 the bottom part of which is connected to the upper connector 32 of the main body 30 and the top, substantially flat part of which comprises bristles 51 that are parallel to each other. The top part of the rigid element 50 extends longitudinally and also comprises ejection orifices 52 suitable for ejecting ozonated water in the direction of the bristles 51 in order to act when brushing the teeth. The ejection orifices 52 are connected fluidly to the bottom part of the cleaning head 5 by internal channels, not shown.

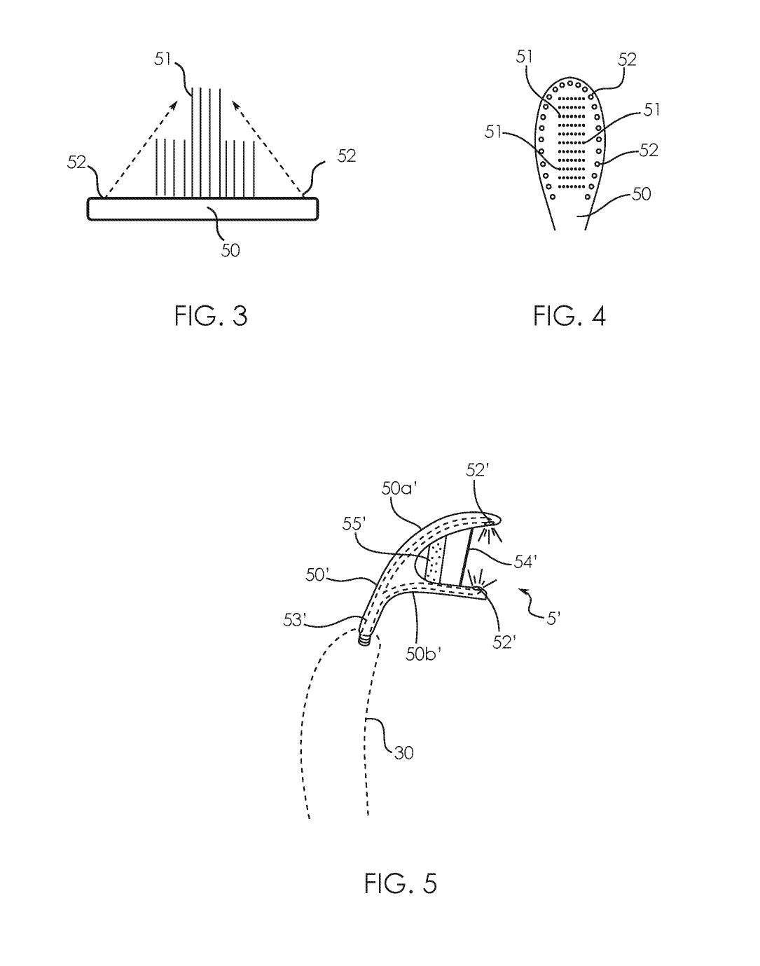

Preferably, with reference to FIG. 4, the ejection orifices 52 are arranged around the periphery of the top part of the rigid element 50, in other words, around the bristles 51 of the cleaning head 5. There is no ejection orifice 52 between the bristles 51. With reference to FIG. 3, the bristles 51 of the cleaning head 5 are not all of the same length, the bristles being longer in the center of the cleaning head 5 and shorter around the periphery so as to facilitate brushing of the teeth of the upper (lower) jaw by a semi-circular downward (upward) movement. The ejection orifices 52 are inclined in order to reach the top quarter of the bristles 51 located in the center of the cleaning head 5 to enable optimum action of the ozone during cleaning while avoiding interference with the other bristles. Preferably, the bristles 51 define a curved profile as shown in FIG. 3.

Advantageously, the jets of ozonated water do not therefore come into direct contact with the teeth, which could damage the gums and lead to loosening of the teeth and/or gingival recession. Thanks to the invention, the hot ozonated water is emitted onto the bristles 51 that brush away the residues and treat the gum, which is cleaned, disinfected and strengthened during brushing.

Advantageously, the cleaning element 3 can accommodate different cleaning heads so as to enable different types of cleaning.

With reference to FIG. 5, the cleaning head 5′ is the dental-floss type and comprises a rigid element 50′, the bottom part of which is connected to the upper connector 32 of the main body 30 and the top part of which comprises two portions 50a, 50b spaced apart, between which a stretched length of dental floss 54′ is mounted. The dental floss 54′ is preferably made of silk. Preferably, each portion 50a, 50b of the rigid element 50′ comprises an ejection orifice 52′ suitable for ejecting ozonated water in order to act when the dental floss 54′ passes between the teeth. The ejection orifices 52′ are connected fluidly to the bottom part of the cleaning head 5′ by internal channels 53′. Advantageously, each ejection orifice 52′ allows ozonated water to flow towards the center of the dental floss in order to act directly on the gum and prevent detachment of the gum as well as gingival recession.

Preferably, the cleaning head 5′ comprises an abutment element 55′, preferably of rubber, to limit the insertion of the dental floss 54′ between the teeth and thus limit the risk of injury to the gums. As shown in FIG. 5, the abutment element 55 extends parallel to the dental floss 54′ so as to come into contact with the tips of the teeth when the dental floss 54′ is located between two adjacent teeth. Preferably, the distance between the dental floss 54′ and the abutment element 55′ is between 7 mm and 10 mm.

The dental floss is positioned on the concave side of the main body 30, curved so as to facilitate the introduction of the said dental floss 51 between the teeth.

Preferably the cleaning heads 5, 5′ are disposable and can be replaced when they are worn out.

The dental-floss type cleaning head 5′ is concave in shape. Preferably, the concavity of the main body 30 and the concavity of the cleaning head 5′ are continuous so as to form a dental cleaning device 1 that is uniformly continuous.

### Examples of Use

Preferably, the dental cleaning device 1 is installed in a bathroom. As an example the casing in which the main base 2 is stored is fixed to a vertical wall and the cleaning element 3 is mounted in a support fixed to the wall at an ergonomic height, in particular, between 1 m and 1.5 m. The wall base 2 is connected to the water circuit and to the electrical supply.

Preferably, for hygiene reasons, each user has his own cleaning heads (one brush-type cleaning head 5 and one dental floss-type cleaning head 5′), which can be mounted removably on the main body 30 of the cleaning element 3.

In this example of implementation, the user takes the brush-type cleaning head and connects it mechanically and fluidly to the main body 30 of the cleaning element 3, in particular, by pushing it in.

Before commencing brushing, the user presses the switch to activate the main base 2 and its various components. After activating the feed pump, a flow of water then passes through the carbon filter. The filtered water is then heated by the heating means 26 to a temperature in the order of 50°-55° C., then mixed with the ozone generated by electrolysis by the ozone-injection means 25 in the main base 2. In other words, after activating the cleaning device 1, heated ozonated water is ejected through the ejection orifices 52 of the brush-type cleaning head 5, the heated ozonated water being routed from the main base 2 to the brush-type cleaning head 5 through the main pipe 4 and the body 30 of the cleaning element 3.

The cleaning element 3 is easy to hold due to the ergonomic shape of the main body 30 and the presence of an indentation 34 in which the user places his thumb.

Teeth brushing by the user is particularly effective given that the flow of water is ejected directly onto the brushing areas, enabling residues to be quickly removed without them being deposited on other teeth. Furthermore, the heated water dissolves sugary residues and increases the blood circulation of the gums so as to increase their resistance to inflammation. The presence of ozone in the flow of water is particularly advantageous because it avoids the use of toothpaste, which is not tolerated by all users. Furthermore, unlike toothpaste, which presents a risk for children in the event of ingestion, ozonated water is risk free. Indeed, ozonated water enables optimum disinfection of the teeth and oral cavity and effectively combats tooth decay.

The shape of the bristles 51 of the brush-type cleaning head 5 facilitates the ejection of ozonated hot water from the periphery of the cleaning head 5 towards its center, the bristles 51 thus presenting no obstacle likely to block the jets of water coming from the ejection orifices 52. The rinsing of teeth is thus achieved under the best conditions.

Advantageously, given that the cleaning head 5 is removable, it can easily be replaced in the event of wear. This replacement has no impact on the other parts of the cleaning device 1, which is economical.

Once the user has brushed and rinsed his teeth, he deactivates the main base 2 by pressing the switch.

In this example of implementation, the user wishes to complete his cleaning by using dental floss. For this purpose, the user replaces the brush-type cleaning head 5 with a dental-floss type cleaning head 5′. In a way similar to that described previously, the user takes the dental-floss type cleaning head 5′ and mechanically and fluidly connects it to the main body 30 of the cleaning element 3, preferably by pushing it in.

The dental floss 54′ is positioned between two adjacent teeth in order to remove any undesirable residue. During cleaning, the dental floss 54′ is substantially orthogonal to the axis in which the teeth extend. The orientation of the jets of water coming from the ejection orifices 52′ is particularly suitable for cleaning the dental floss 54′ during cleaning so as to avoid moving the residues from one tooth to another. The use of ozonated water also enables the space between the teeth to be protected and disinfected, which represents an important advantage compared to the prior art. Moreover, the presence of the abutment element prevents any contact of the dental floss 54′ with the gums, thus ensuring user comfort.

Thanks to the invention, a user can, with the aid of a single cleaning device 1, thoroughly and effectively clean his teeth. The use of heated ozonated water is particularly advantageous given that it eliminates the need for toothpaste and can also be used when flossing the teeth.

1. Dental cleaning device for personal use, said device comprising:
a main base comprising at least one drinking water inlet and one water outlet, and
a cleaning element suitable to be hand held by a user and fluidly connected to the said main base, the said cleaning element comprising a plurality of water ejection orifices enable the teeth to be rinsed,
said device characterized in that the main base comprises ozone injection means so as to supply ozonated water to disinfect the teeth when rinsing.

2. Dental cleaning device according to claim 1, wherein the ozone injection means are configured to generate ozone by electrolysis of the drinking water.

3. Dental cleaning device according to claim 1, wherein the main base comprises heating means so as to supply ozonated, heated water to disinfect the teeth during rinsing.

4. Dental cleaning device according to claim 1, wherein the cleaning element comprises a main body onto which a cleaning head is removably mounted, the said cleaning head comprising a plurality of water ejection orifices to enable the user's teeth to be rinsed.

5. Dental cleaning device according to claim 1, wherein the cleaning head is of the brush type and comprises a rigid element comprising a plurality of bristles, the ejection orifices being arranged around the periphery of said rigid element.

6. Dental cleaning device according to claim 5, wherein the rigid element extending longitudinally, the bristles are longer in the center of the rigid part than at its ends in a cross-sectional plane.

7. Dental cleaning device according to claim 1, wherein the cleaning head is the dental-floss type and comprises a rigid element comprising two portions spaced apart, between which a stretched length of dental floss is mounted.

8. Dental cleaning device according to claim 7, wherein each spaced-apart portion comprises at least one ejection orifice.

9. Dental cleaning device according to claim 8, wherein each ejection orifice is oriented towards the said dental floss.

10. Dental cleaning device according to claim 7, wherein the dental-floss type cleaning head comprises an abutment element parallel to said dental floss.
